(19) United States
(12) Patent Application Publication
(10) Pub. No.: US 2025/0329129 A1
(43) Pub. Date: Oct. 23, 2025

(54) COMPUTER-READABLE RECORDING MEDIUM STORING SHIP INFORMATION MEASUREMENT PROGRAM, SHIP INFORMATION MEASUREMENT METHOD, AND SHIP INFORMATION MEASUREMENT DEVICE

(71) Applicant: Fujitsu Limited, Kawasaki-shi (JP)

(72) Inventor: Yo NOMURA, Yokohama (JP)

(73) Assignee: Fujitsu Limited, Kawasaki-shi (JP)

(21) Appl. No.: 19/066,914

(22) Filed: Feb. 28, 2025

(30) Foreign Application Priority Data
Apr. 22, 2024 (JP) 2024-069377

(51) Int. Cl. G06V 10/44

(52) U.S. Cl. CPC G06V 10/44

(57) ABSTRACT

A non-transitory computer-readable recording medium stores a program for causing a computer to execute a process for measuring ship information which includes: imaging a predetermined vessel with an image acquisition device to obtain a captured image of the predetermined vessel; extracting a feature point of the predetermined vessel in the captured image based on an output obtained by inputting the obtained captured image to a machine learning model that extracts a feature point of a vessel from an image; obtaining a distance from the image acquisition device to a horizontal plane on which the predetermined vessel is positioned; obtaining an inclination angle of the image acquisition device with respect to the horizontal plane; and identifying the ship information of the predetermined vessel based on a position of the feature point in the captured image, the distance, and the inclination angle.

### CROSS-REFERENCE TO RELATED APPLICATION

This application is based upon and claims the benefit of priority of the prior Japanese Patent Application No. 2024-69377, filed on Apr. 22, 2024, the entire contents of which are incorporated herein by reference.

### FIELD

The embodiment discussed herein is related to a ship information measurement program, a ship information measurement method, and a ship information measurement device.

### BACKGROUND

A position, dimension, and azimuth of a vessel are very important as main attributes representing the vessel, for example, as ship information. Those pieces of information are used as basic numerical values in a wide range of application fields such as determination of a ship type or the like, selection of a shipping route in marine traffic, and collision avoidance.

Japanese Laid-open Patent Publication No. 2005-83775 and Japanese Laid-open Patent Publication No. 2012-256131 are disclosed as related art.

### SUMMARY

According to an aspect of the embodiments, a non-transitory computer-readable recording medium stores a program for causing a computer to execute a process for measuring ship information which includes: imaging a predetermined vessel with an image acquisition device to obtain a captured image of the predetermined vessel; extracting a feature point of the predetermined vessel in the captured image based on an output obtained by inputting the obtained captured image to a machine learning model that extracts a feature point of a vessel from an image; obtaining a distance from the image acquisition device to a horizontal plane on which the predetermined vessel is positioned; obtaining an inclination angle of the image acquisition device with respect to the horizontal plane; and identifying the ship information of the predetermined vessel based on a position of the feature point in the captured image, the distance, and the inclination angle.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary operation method of a ship information measurement device according to an embodiment;

FIG. 2 is a diagram illustrating feature points and dimensions of ship information;

FIG. 3 is a diagram illustrating an example of a ship length and a ship width;

FIG. 4 is an image view of an installation state and an appearance of the ship information measurement device;

FIG. 5 is a block diagram of the ship information measurement device;

FIG. 6 is a diagram for explaining various coordinate systems;

FIG. 7 is a diagram illustrating a process of extracting feature points performed by an image recognition unit;

FIG. 8 is a diagram illustrating a method of obtaining a conversion coefficient for converting a pixel position in an image coordinate system into a screen coordinate system;

FIG. 9 is a diagram illustrating conversion from a screen coordinate system into a camera coordinate system;

FIG. 10 is a diagram illustrating a relationship between a point in a virtual projection plane and a point in a real space;

FIG. 11 is a diagram illustrating a relationship between a point in the real space and an image acquisition device;

FIG. 12 is a diagram illustrating a relationship between an angle obtained from an inclination measurement unit and an Euler angle;

FIG. 13 is a flowchart of a process of measuring ship information performed by the ship information measurement device according to the embodiment;

FIG. 14 is a diagram for explaining calculation of a measurement error;

FIG. 15 is a diagram illustrating an accuracy measurement result; and

FIG. 16 is a hardware configuration diagram of a computer.

### DESCRIPTION OF EMBODIMENTS

It is commonly conceivable to use, as a technique of obtaining such main attributes representing a vessel, an automatic identification system (AIS) that transmits the attributes by the vessel itself. The AIS is a system that automatically transmits and receives information associated with an identification code, a type, a position, a course, a speed, a navigational status, and other safety information of a vessel with very high frequency (VHF) radio waves, and exchanges information between ship stations and between a ship station and a navigation support facility or the like of a land station. Although the AIS is preferable as a tool for easily obtaining ship information, since the transmission is made by the vessel itself, there is a problem that accurate information may not necessarily be obtained at all times due to a failure of a transmission device, a human error such as a setting error, setting omission, or the like, intentional falsification, intentional disconnection of equipment, or the like. In such a case, it is preferable to directly obtain the ship information by measurement or the like as described below.

The following three techniques are available as a method of measuring dimensions of a large structure, such as a vessel, in a non-contact manner. One is a measurement method using a device such as a three-dimensional laser. For example, a dimension of a vessel may be measured by a three-dimensional laser scanner device being moved along the vessel for scanning to obtain three-dimensional positional information of a hull surface shape. Another one is a method of measuring dimensions using an image.

The remaining one is a method using deep learning of segmentation. For example, a region that may be used for dimension measurement in an image in which an object to be measured is captured is surrounded as segmentation, deep learning is carried out using the segmentation, and a result of the deep learning is used, whereby the dimension of the vessel may be obtained.

Note that, as a technique of measuring a dimension of an object, there is a technique of specifying a portion having the maximum width in the longitudinal and lateral directions in a captured image obtained by imaging a grain and calculating the maximum width of the grain. Furthermore, as a technique of detecting a shape of an object, there is a technique of executing local regression fitting (LRF) training using a captured image of an object and detecting part points of the object from the obtained captured image.

However, the method of measuring dimensions using a device such as three-dimensional laser needs expensive equipment and various operations such as installation of a reflective target for an object to be measured, and thus it is difficult to carry out easy and accurate measurement. Furthermore, in the method of measuring dimensions using an image, an operation of inputting a point to be measured in the image using a mouse or the like is a manual operation so that it is difficult to carry out the measurement automatically, and thus it is difficult to carry out easy and accurate measurement. Moreover, in the method using deep learning of segmentation, the deep learning is based on the task of surrounding a region as segmentation so that rough dimensions are obtained with respect to an outer shape, and thus it is difficult to obtain dimensions as defined, such as a total length, maximum width, and the like of the vessel. Furthermore, the method of using deep learning of segmentation processes the vessel as two-dimensional information, and thus it is difficult to accurately obtain attitude information of the vessel such as an azimuth. Thus, it is difficult to carry out easy and accurate measurement.

Furthermore, it is difficult to directly use the technique of calculating a dimension of a grain or the technique of detecting a part point of an object using the LRF training for obtaining information regarding a vessel on the sea, and it is difficult to easily and accurately measure ship information with those techniques.

The disclosed technique has been conceived in view of the above, and an object is to provide a ship information measurement program, a ship information measurement method, and a ship information measurement device that easily and accurately measure ship information.

Hereinafter, an embodiment of a ship information measurement program, a ship information measurement method, and a ship information measurement device disclosed in the present application will be described in detail with reference to the drawings. Note that the ship information measurement program, the ship information measurement method, and the ship information measurement device disclosed in the present application are not limited by the following embodiment.

### EMBODIMENT

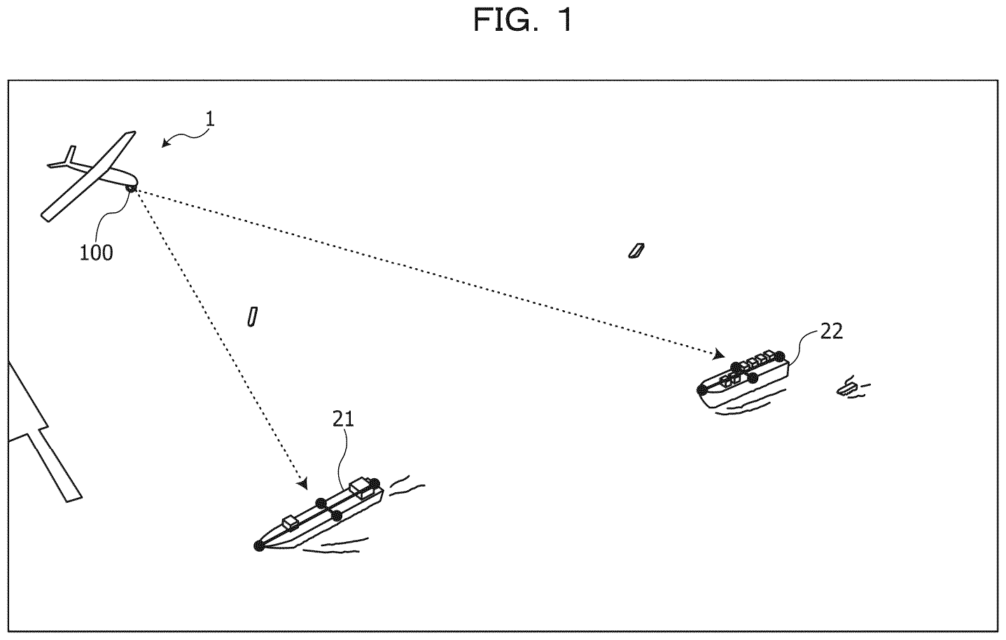

FIG. 1 is a diagram illustrating an exemplary operation method of the ship information measurement device according to the embodiment. A ship information measurement device 100 according to the present embodiment is installed in an unmanned aircraft 1 as illustrated in FIG. 1, for example. The unmanned aircraft 1 is a drone, a radio-controlled aircraft, or the like. However, the ship information measurement device 100 only needs to be disposed at a position from which a vessel on the sea may be captured, and may be installed on a manned aircraft, a balloon, or the like, or may be placed on a tower at sea. In the unmanned aircraft 1 flying over the sea, the ship information measurement device 100 measures ship information including positions, dimensions, and azimuths of vessels 21 and 22 floating on the sea.

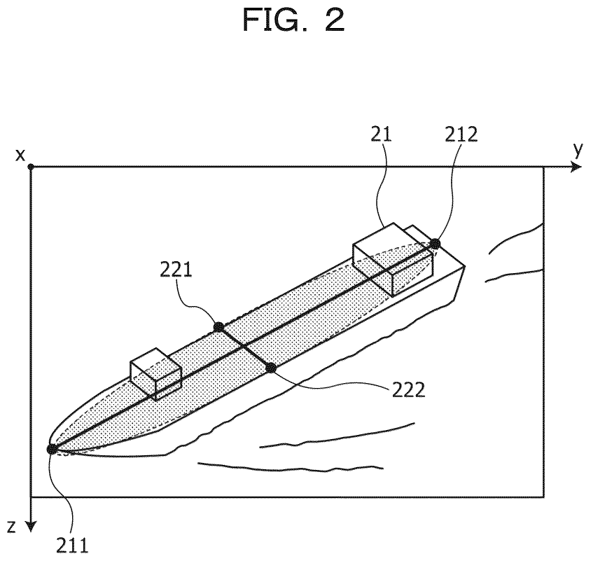

FIG. 2 is a diagram illustrating feature points and dimensions of the ship information. Here, the vessel 21 will be described as an example. For example, the ship information measurement device 100 obtains an image of the vessel 21, and specifies positions of feature points 211, 212, 221, and 222 in a three-dimensional space using the obtained image. The feature point 211 corresponds to the bow of the vessel 21, and the feature point 212 corresponds to the stern of the vessel 21. In addition, the feature point 221 corresponds to the starboard side of the vessel 21, and the feature point 222 corresponds to the portside of the vessel 21.

Then, the ship information measurement device 100 calculates a ship length, which is a distance from the feature point 211 corresponding to the bow to the feature point 212 corresponding to the stern. Furthermore, the ship information measurement device 100 calculates a ship width, which is a distance from the feature point 221 corresponding to the starboard side to the feature point 222 corresponding to the portside.

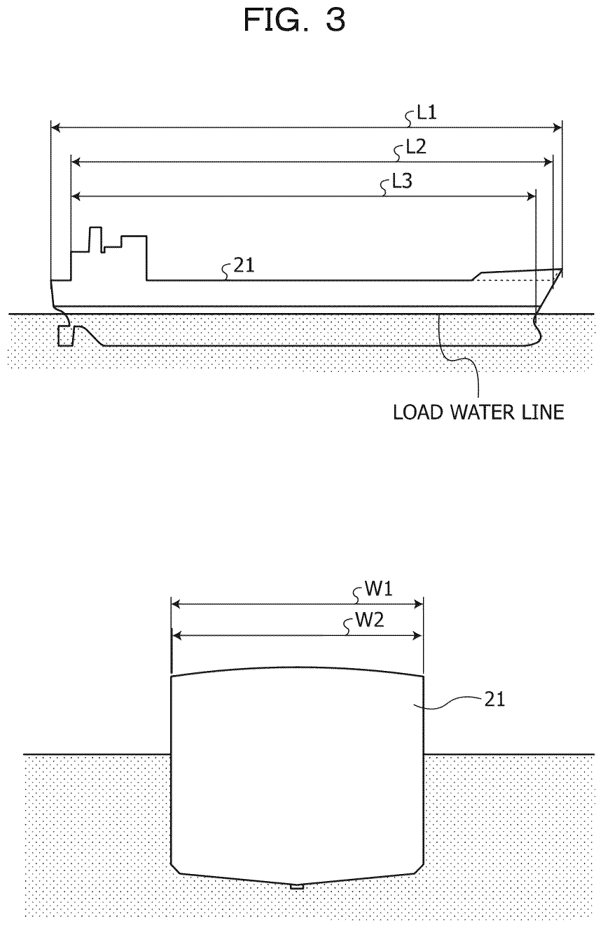

FIG. 3 is a diagram illustrating an example of the ship length and the ship width. A length L1 of the vessel 21 is referred to as a total length. In addition, a length L2 of the vessel 21 is referred to as a registered length. In addition, a length L3 of the vessel 21 is referred to as a length between perpendiculars. The ship information measurement device 100 may handle any of the lengths L1 to L3 as a ship length by changing objects to be extracted as the feature points 211 and 212.

Furthermore, a width W1 of the vessel 21 is referred to as a maximum width. In addition, a width W2 of the vessel 21 is referred to as a molded breadth or a registered breadth. The ship information measurement device 100 may handle both the widths W1 and W2 as a ship width by changing objects to be extracted as the feature points 221 and 222.

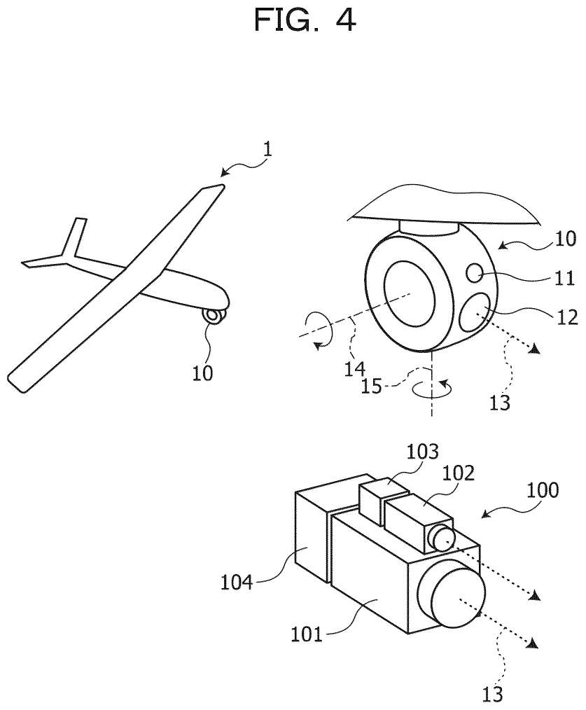

FIG. 4 is an image view of an installation state and an appearance of the ship information measurement device. The ship information measurement device 100 is stored in a two-axis gimbal 10 installed under the lower surface of the fuselage near the head of the unmanned aircraft 1. As illustrated in FIG. 4, the two-axis gimbal 10 has openings 11 and 12. Moreover, the two-axis gimbal 10 has an elevator (EL) axis 14 and an azimuth (AZ) axis 15 as rotation axes. For example, the two-axis gimbal 10 rotates around the EL axis 14 in a direction perpendicular to the fuselage of the unmanned aircraft 1. In addition, the two-axis gimbal 10 rotates around the AZ axis 15 in a direction parallel to the fuselage of the unmanned aircraft 1. The two-axis gimbal 10 stores the ship information measurement device 100.

As illustrated in FIG. 4, the ship information measurement device 100 includes a camera 101, a distance meter 102, an inclinometer 103, and a computer 104. When the ship information measurement device 100 is stored in the two-axis gimbal 10, it is disposed such that an imaging lens of the camera 101 faces the opening 12. In this case, as illustrated in FIG. 4, a visual axis 13 of the camera 101 is positioned in a direction from the opening 12 of the two-axis gimbal 10 toward the outside. Furthermore, in a case of a laser distance meter, for example, the distance meter 102 is disposed such that a laser emission lens faces the opening 11 of the two-axis gimbal 10.

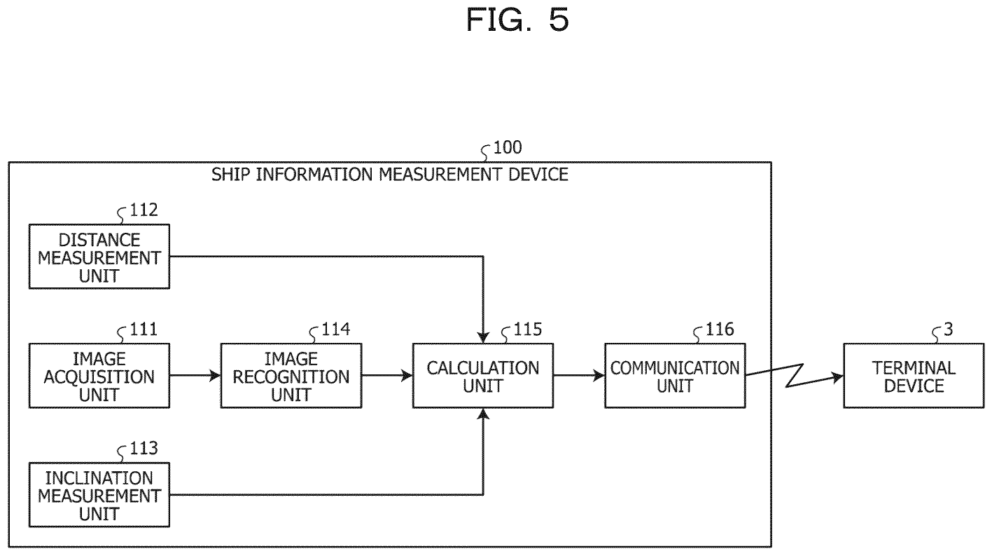

FIG. 5 is a block diagram of the ship information measurement device. Next, details of the ship information measurement device 100 will be described with reference to FIG. 5. As illustrated in FIG. 5, the ship information measurement device 100 includes an image acquisition unit 111, a distance measurement unit 112, an inclination measurement unit 113, an image recognition unit 114, a calculation unit 115, and a communication unit 116.

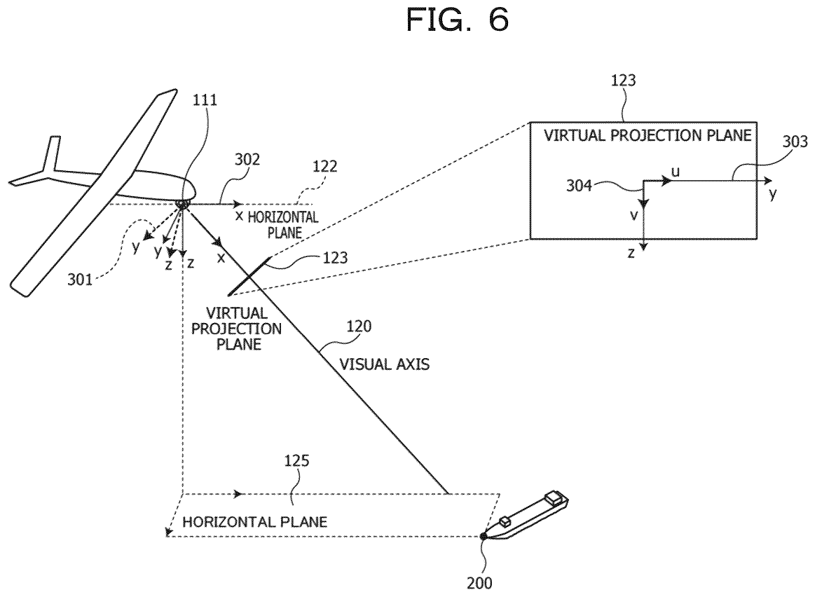

FIG. 6 is a diagram for explaining various coordinate systems. In the following descriptions, four coordinate systems will be used including a camera coordinate system Σ_{CAM}, a camera horizontal coordinate system Σ_{HDR}, a screen coordinate system Σ_{SCR}, and an image coordinate system Σ_{IMG}.

The camera coordinate system Σ_{CAM} corresponds to a coordinate system 301 in FIG. 6. The camera coordinate system Σ_{CAM} is a coordinate system fixed with respect to the image acquisition unit 111, and is a coordinate system with an optical center of the image acquisition unit 111 as an origin, a visual axis 120 as a +x-axis, a downward direction of the image acquisition unit 111 with respect to the visual axis 120 as a +z-axis, and an axis perpendicular to the x-axis and the z-axis as a y-axis. A unit of each of an x component, a y component, and a z component in the camera coordinate system Σ_{CAM} is meter (m).

The camera horizontal coordinate system Σ_{HOR} corresponds to a coordinate system 302 in FIG. 6. The camera horizontal coordinate system Σ_{HOR} is a coordinate system in which the camera coordinate system Σ_{CAM} is rotated around the x-axis and the y-axis, the z-axis is directed from the optical center of the image acquisition unit 111 toward the vertical direction with respect to the ground surface, and the x-axis is determined such that the visual axis 120 exists on the xz plane of the camera horizontal coordinate system Σ_{HOR}. The x-axis of the camera horizontal coordinate system Σ_{HOR} exists on a horizontal plane 122 with respect to the ground surface passing through the optical center of the camera 101 included in the image acquisition unit 111. A unit of each of the x component, the y component, and the z component in the camera horizontal coordinate system Σ_{HOR} is meter (m).

The screen coordinate system Σ_{SCR} corresponds to a coordinate system 303 in FIG. 6. The screen coordinate system Σ_{SCR} is a coordinate system obtained by parallelly moving the camera coordinate system Σ_{CAM} along the visual axis 120 toward the vessel 21 by a focal length, and is a coordinate system virtually arranged by a perspective projection model. Here, a virtual projection plane 123 is a plane in which a normal line corresponds to the visual axis 120 at a position where the camera coordinate system Σ_{CAM} in the perspective projection model is parallelly moved along the visual axis 120 toward the vessel 21 by the focal length. In the screen coordinate system Σ_{SCR}, the y-axis and the z-axis are positioned on the virtual projection plane 123. While the y-axis and the z-axis in the virtual projection plane 123 are illustrated in the coordinate system 303 in FIG. 6, the screen coordinate system Σ_{SCR} has the x-axis in a depth direction of FIG. 6. A unit of each of the x component, the y component, and the z component in the screen coordinate system Σ_{SCR} is meter (m), and the x component is zero at all times.

The image coordinate system Σ_{IMG} corresponds to a coordinate system 304 in FIG. 6. The image coordinate system Σ_{IMG} is a two-dimensional coordinate system that represents coordinates in the virtual projection plane 123 of the perspective projection model, and corresponds to pixels of an image. The image coordinate system Σ_{IMG} has a u-axis and a v-axis. The u-axis overlaps with the y-axis in the screen coordinate system Σ_{SCR}. A v coordinate overlaps with a z coordinate in the screen coordinate system Σ_{SCR}. A unit of each of a u component and a v component in the image coordinate system Σ_{IMG} is pixel.

For example, a feature point 200 in FIG. 6 is to be extracted by the ship information measurement device 100. As illustrated in FIG. 6, the feature point 200 to be extracted may exist at a position deviated from the visual axis 120.

Note that the ship information measurement device 100 is configured such that the x-axis of the camera 101 of the image acquisition unit 111, the x-axis of the distance measurement unit 112, and the x-axis of the inclination measurement unit 113 match with each other. Here, the x-axis of the camera 101 of the image acquisition unit 111 corresponds to the visual axis 120 of the camera 101 of the image acquisition unit 111. In addition, the x-axis of the distance measurement unit 112 corresponds to the direction in which a distance is to be measured.

The image acquisition unit 111 includes the camera 101 in FIG. 4. The image acquisition unit 111 captures an image of the vessel 21 as an information acquisition target using the camera 101, and obtains the image of the vessel 21. Then, the image acquisition unit 111 outputs the obtained image data of the vessel 21 to the image recognition unit 114.

The distance measurement unit 112 is implemented by the distance meter 102 in FIG. 4. The distance measurement unit 112 measures a distance from the optical center to a horizontal plane on which the vessel ahead of the visual axis 120 is positioned in the imaging by the image acquisition unit 111. This distance is, when the visual axis 120 corresponds to the sea surface, a distance from the optical center to the sea surface in the imaging by the image acquisition unit 111. Then, the distance measurement unit 112 outputs the measured distance data to the calculation unit 115.

The inclination measurement unit 113 is implemented by the inclinometer 103 in FIG. 4. The inclination measurement unit 113 obtains, as an inclination angle with respect to the horizontal plane on which the vessel is positioned, a roll angle and a pitch angle of an imaging lens of the image acquisition unit 111 with respect to the camera horizontal coordinate system Σ_{HOR} at all times. The inclination measurement unit 113 outputs information regarding the measured roll angle and pitch angle to the calculation unit 115.

The image recognition unit 114 receives an input of image data from the image acquisition unit 111. Then, the image recognition unit 114 extracts the feature points 211, 212, 221, and 222 of the vessel 21 in the image. Here, a process of extracting the feature point 211 from the image by the image recognition unit 114 will be described using the feature point 211 as an example.

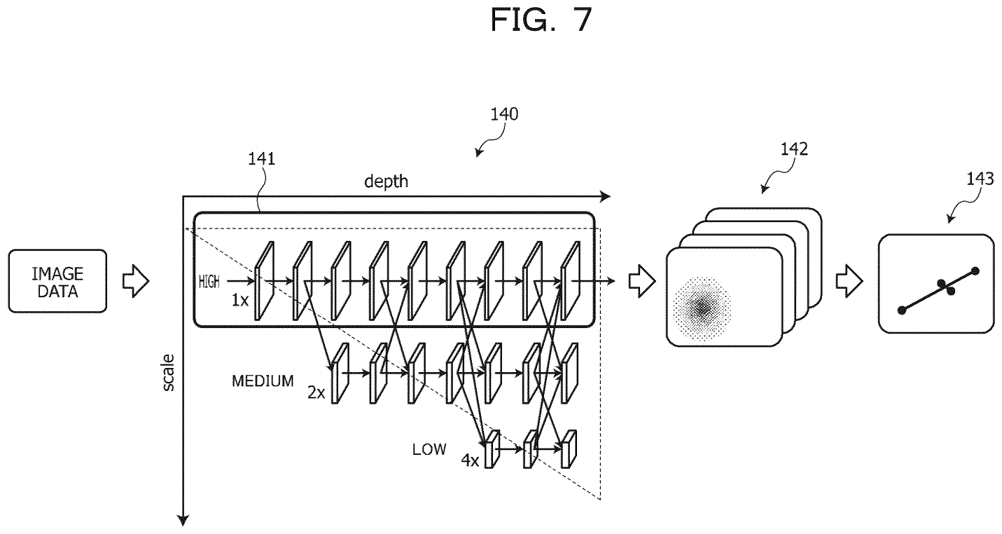

FIG. 7 is a diagram illustrating the process of extracting feature points performed by the image recognition unit. For example, the image recognition unit 114 includes a neural network 140, which is a trained machine learning model to be used to extract the feature point 211 from the image data.

The neural network 140 may use, for example, a high-resolution network (HRNet) capable of highly accurately estimating a position of the point of the feature point 211 from the image. In the case of the NRNet, the neural network 140 includes a high-resolution network 141 in which the resolution is not reduced in parallel with the network that carries out narrowing for the feature point extraction. Then, the neural network 140 estimates the feature point 211 using the high-resolution network 141 together with the network that carries out narrowing for the feature point extraction. The neural network 140 carries out supervised learning using image data having a position of each feature point as a teacher label. Note that, by creating the teacher labels according to the definitions of various dimensions illustrated in FIG. 3, the ship information measurement device 100 is enabled to perform measurement according to various dimension definitions.

The image recognition unit 114 inputs image data of the vessel 21 to the neural network 140. Thereafter, the image recognition unit 114 obtains probability distribution 142 of the position of the feature point 211 as an output from the neural network 140. Then, the image recognition unit 114 estimates a position 143 of the feature point 211 in the image using the probability distribution of the position of the feature point 211. As described above, the image recognition unit 144 obtains the position 143 of the feature point 211 from the probability distribution 142 of the position of the feature point 211, whereby the position 143 of the feature point 211 may be recognized from the surrounding information even if the feature point 211 is not directly present in the image. For example, the ship information measurement device 100 recognizes the feature point 211 in the entire surrounding images, whereby the ship information may be measured even if there is a partially invisible point.

Thereafter, the image recognition unit 114 outputs the extracted feature points 211, 212, 221, and 222 of the vessel 21 to the calculation unit 115.

The calculation unit 115 receives an input of the distance data from the distance measurement unit 112. Furthermore, the calculation unit 115 receives, from the inclination measurement unit 113, an input of information regarding the roll angle and pitch angle of the image acquisition unit 111. Moreover, the calculation unit 115 receives, from the image recognition unit 114, an input of the positional information of the feature points 211, 212, 221, and 222 of the vessel 21 in the image.

Then, the calculation unit 115 calculates positions of the feature points 211, 212, 221, and 222 in the real space using the distance data, the information regarding the roll angle and pitch angle of the image acquisition unit 111, and the positional information of the feature points 211, 212, 221, and 222. Here, the calculation unit 115 converts each of the feature points 211, 212, 221, and 222 into a position in the real space, and each processing is similar. Thus, hereinafter, the feature point 211 will be described as an example.

The calculation unit 115 converts the pixel position in the image coordinate system Σ_{IMG} in the image of the extracted feature point 211 into the screen coordinate system Σ_{SCR} using the following formula (1). Hereinafter, the feature point 211 represented in the image will be referred to as a feature point 211′.

$$[ Math . 1 ]$$

$${}^{SCR} p = \{ \begin{matrix}0 \\ {a}^{u} \times u \\ {a}^{v} \times v\end{matrix} \} \qquad ( 1 )$$

Here, a^{u} and a^{v} represent conversion coefficients for converting the pixel position in the image coordinate system Σ_{IMG} into the screen coordinate system Σ_{SCR}. A unit of a^{u} and a^{v} is “m/pixel”. Furthermore, u and v represent a position of the feature point 211′ in the image coordinate system Σ_{IMG}, and a unit is “pixel”. ^{SCR}p represents a position vector of the feature point 211′ in the virtual projection plane 123 viewed from the screen coordinate system Σ_{SCR}.

The screen coordinate system Σ_{SCR} corresponds to an example of a “first coordinate system”. For example, the calculation unit 115 converts the position of the feature point in the captured image into a position in the first coordinate system with the imaging direction of the camera 101 serving as a reference.

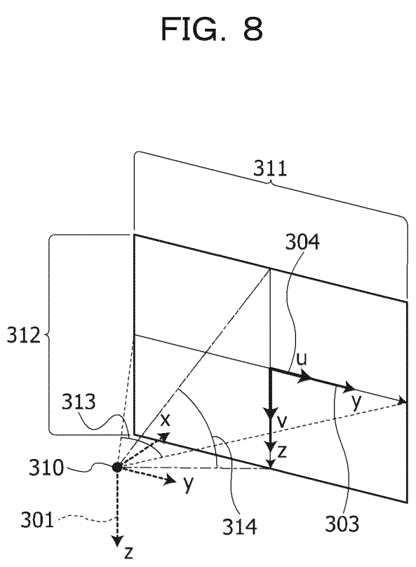

FIG. 8 is a diagram illustrating a method of obtaining the conversion coefficient for converting a pixel position in the image coordinate system into the screen coordinate system. The coordinate system 301 in FIG. 8 corresponds to the camera coordinate system Σ_{CAM}, and a point 310 corresponds to the origin of the camera coordinate system Σ_{CAM}. In addition, the coordinate system 303 corresponds to the screen coordinate system Σ_{SCR}.

The conversion coefficients for converting the pixel position in the image coordinate system Σ_{IMG} into the screen coordinate system Σ_{SCR}, which are represented by a^{u} and a^{v}, are expressed by the following formulae (2) and (3) from the definition of a tangent of a right triangle.

$$[ Math . 2 ]$$

$${a}^{u} = \frac{{pic}_{H}}{2} \times \frac{1}{f \times tan ( \frac{{FOV}_{H}}{2} )} \qquad ( 2 )$$

$$[ Math . 3 ]$$

$${a}^{v} = \frac{{pic}_{V}}{2} \times \frac{1}{f \times tan ( \frac{{FOV}_{V}}{2} )} \qquad ( 3 )$$

Here, pic_{H} corresponds to an image horizontal pixel 311 in FIG. 8, and pic_{V} corresponds to an image vertical pixel 312 in FIG. 8. In addition, FOV_{H} corresponds to a horizontal angle of view 313 in FIG. 8, and FOV_{V} corresponds to a vertical angle of view 314 in FIG. 8.

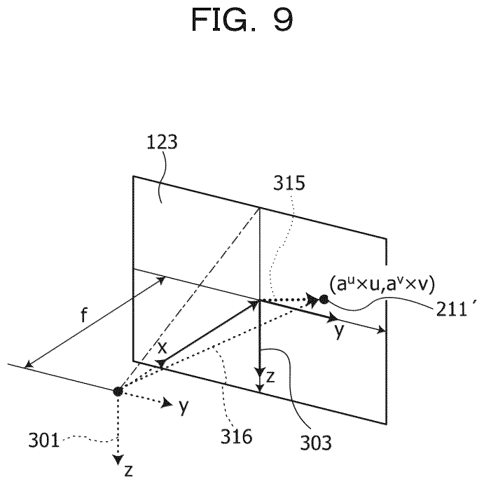

FIG. 9 is a diagram illustrating conversion from the screen coordinate system into the camera coordinate system. The coordinate system 301 in FIG. 9 corresponds to the camera coordinate system Σ_{CAM}, and the coordinate system 303 corresponds to the screen coordinate system Σ_{SCR}. The camera coordinate system Σ_{CAM} and the screen coordinate system Σ_{SCR} are separated from each other by a focal length f in the x-axis direction.

The calculation unit 115 converts the position vector of the feature point 211′ in the screen coordinate system Σ_{SCR} into the position vector in the camera coordinate system Σ_{CAM} using the following formula (4) obtained from a relational expression of vectors in the camera coordinate system Σ_{CAM} and the screen coordinate system Σ_{SCR}. Here, ^{CAM}p represents a position vector of the feature point 211′ in the camera coordinate system Σ_{CAM}.

$$[ Math . 4 ]$$

$${}^{CAM} p = \{ \begin{matrix}f \\ 0 \\ 0\end{matrix} \} + {}^{SCR} p \qquad ( 4 )$$

For example, as illustrated in FIG. 9, the calculation unit 115 converts a position vector 315 of the feature point 211 in the screen coordinate system Σ_{SCR} into a position vector 316 of the feature point 211′ in the camera coordinate system Σ_{CAM}.

Next, the calculation unit 115 converts, using the following formula (5), the position vector of the feature point 211′ expressed in the camera coordinate system Σ_{CAM} into a position vector in the camera horizontal coordinate system Σ_{HOR}.

$$[ Math . 5 ]$$

$$\begin{matrix}{}^{HOR} p = {}^{HOR} {R}_{CAM} \times {}^{CAM} p \\ = {}^{HOR} {R}_{CAM} \times [ \{ \begin{matrix}f \\ 0 \\ 0\end{matrix} \} + {}^{SCR} p ] \\ = {}^{HOR} {R}_{CAM} \times \{ \begin{matrix}f \\ {a}^{u} \times u \\ {a}^{v} \times v\end{matrix} \} \\ = [ \begin{matrix}{c}_{θ y} & {s}_{θ y} & {s}_{θ x} & {s}_{θ y} & {c}_{θ x} \\ 0 & {c}_{θ x} & & - {s}_{θ x} & \\ - {s}_{θ y} & {c}_{θ y} & {s}_{θ x} & {c}_{θ y} & {c}_{θ x}\end{matrix} ] \times \{ \begin{matrix}f \\ {a}^{u} \times u \\ {a}^{v} \times v\end{matrix} \}\end{matrix} \qquad ( 5 )$$

Here, ^{HOR}P represents a position vector of the feature point 211′ in the camera horizontal coordinate system Σ_{HOR}. In addition, ^{HOR}R_{CAM} represents a coordinate transformation matrix for converting a position vector in the camera coordinate system Σ_{CAM} into a position vector in the camera horizontal coordinate system Σ_{HDR}. The coordinate transformation matrix ^{HOR}R_{CAM} is a matrix that matches the camera coordinate system Σ_{CAM} with the camera horizontal coordinate system Σ_{HDR} by rotating the camera coordinate system Σ_{CAM} by θy with respect to the Y-axis of the camera horizontal coordinate system Σ_{HDR} and then making rotation by θx with respect to the X-axis of the rotated camera coordinate system Σ_{CAM}. In addition, S represents sin. For example, S_{θy}=sin(6y) holds. In addition, C represents cos. For example, C_{θy}=cos(θy) holds.

Here, the calculation unit 115 may generate ^{HOR}R_{CAM} as follows. The calculation unit 115 multiplies a simple matrix I_{3×3} by a basic rotation matrix regarding the Y-axis expressed by the following formula (7) to rotate θy with respect to the Y-axis of the camera horizontal coordinate system Σ_{HDR} from the left. Next, the calculation unit 115 generates ^{HOR}R_{CAM} by multiplying a basic rotation matrix regarding the X-axis expressed by the following formula (6) to rotate θx with respect to the X-axis of the rotated camera coordinate system Σ_{CAM}.

$$[ Math . 6 ]$$

$${R}_{x} = [ \begin{matrix}1 & 0 & 0 \\ 0 & {C}_{θ x} & - {S}_{θ x} \\ 0 & {S}_{θ x} & {C}_{θ x}\end{matrix} ] \qquad ( 6 )$$

$$[ Math . 7 ]$$

$${R}_{y} = [ \begin{matrix}{C}_{θ y} & 0 & {S}_{θ y} \\ 0 & 1 & 0 \\ - {S}_{θ y} & 0 & {C}_{θ y}\end{matrix} ] \qquad ( 7 )$$

For example, the calculation unit 115 generates ^{HOR}R_{CAM}, which is a coordinate transformation matrix for converting the position vector of the camera coordinate system Σ_{CAM} into the position vector of the camera horizontal coordinate system Σ_{HOR}, by calculation expressed by the following formula (8).

$$[ Math . 8 ]$$

$$\begin{matrix}{}^{HOR} {R}_{CAM} = {R}_{y} \times {R}_{x} \\ = [ \begin{matrix}{c}_{θ y} & 0 & {s}_{θ y} \\ 0 & 1 & 0 \\ - {s}_{θ y} & 0 & {c}_{θ y}\end{matrix} ] [ \begin{matrix}1 & 0 & 0 \\ 0 & {c}_{θ x} & - {s}_{θ x} \\ 0 & {s}_{θ x} & {c}_{θ x}\end{matrix} ] \\ = [ \begin{matrix}{c}_{θ y} & {s}_{θ y} & {s}_{θ x} & {s}_{θ y} & {c}_{θ x} \\ 0 & {c}_{θ x} & & - {s}_{θ x} & \\ - {s}_{θ y} & {c}_{θ y} & {s}_{θ x} & {c}_{θ y} & {c}_{θ x}\end{matrix} ]\end{matrix} \qquad ( 8 )$$

It is not limited to this, and the calculation unit 115 may generate the coordinate transformation matrix even if the order of rotation is changed. When rotation about the Z-axis is made, the calculation unit 115 may generate the coordinate transformation matrix using a basic rotation matrix regarding the Z-axis expressed by the following formula (9).

$$[ Math . 9 ]$$

$${R}_{z} = [ \begin{matrix}{C}_{θ z} & - {S}_{θ z} & 0 \\ {S}_{θ z} & {C}_{θ z} & 0 \\ 0 & 0 & 1\end{matrix} ] \qquad ( 9 )$$

Here, the camera horizontal coordinate system Σ_{HOR} corresponds to an example of a “second coordinate system”. For example, the calculation unit 115 converts the position of the feature point in the screen coordinate system Σ_{SCR}, which is the first coordinate system, into the position in the camera horizontal coordinate system Σ_{HOR}, which is the second coordinate system with the plane parallel to the horizontal plane serving as a reference.

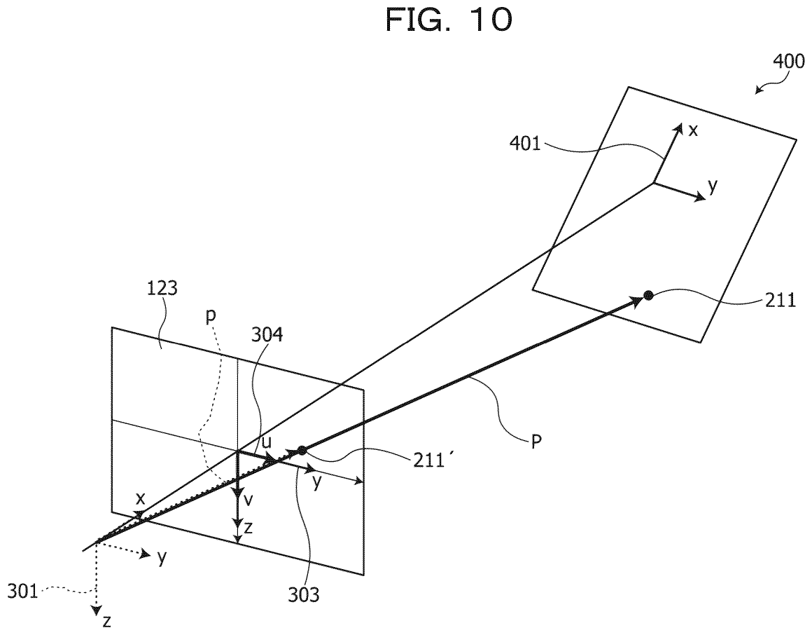

FIG. 10 is a diagram illustrating a relationship between a point in the virtual projection plane and a point in the real space. A coordinate system 401 represents a coordinate space in a real space 400. Here, the feature point 211 is a point in the real space 400. In addition, the feature point 211′ is a point in the virtual projection plane 123.

Next, since a position vector ^{CAM}P₂₁₁ of the feature point 211 in the real space and the position vector ^{CAM}p of the feature point 211′ in the virtual projection plane 123 exist along the same straight line in the camera coordinate system Σ_{CAM}, the calculation unit 115 generates a relational expression between the position vectors ^{CAM}P₂₁₁ and ^{CAM}p. As illustrated in FIG. 10, when the position vector P of the feature point 211 in the real space and the position vector p of the feature point 211′ in the virtual projection plane 123 exist along the same straight line as viewed from the origin of the camera coordinate system Σ_{CAM}, the position vector P may be expressed by a scalar multiple of the position vector p.

Thus, the calculation unit 115 expresses the position vector ^{CAM}P₂₁₁ using ^{CAM}p as expressed by the following formula (10). Here, b represents a scalar.

$$[ Math . 10 ]$$

$${}^{CAM} {P}_{211} b \times {}^{CAM} P \qquad ( 10 )$$

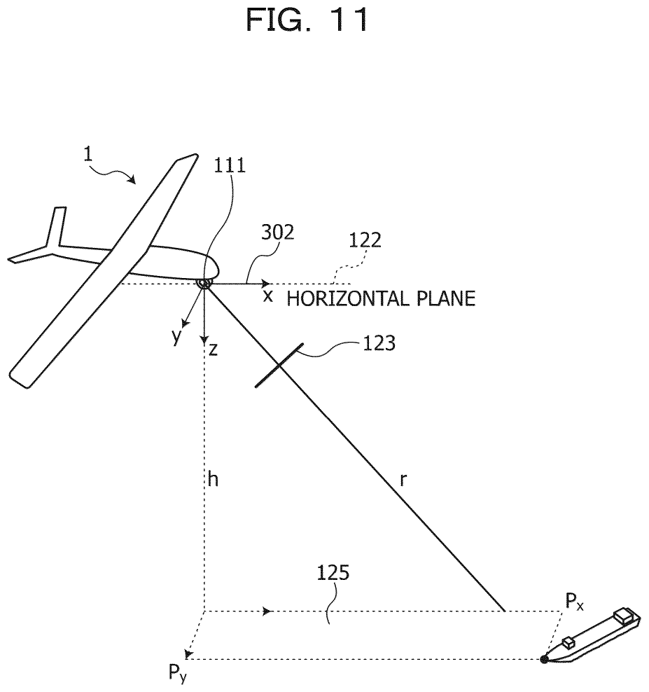

FIG. 11 is a diagram illustrating a relationship between a point in the real space and an image acquisition device. Here, it is assumed that the feature point 211 is in a sea surface 125, and the sea surface 125 is horizontal. In this case, the horizontal plane 122 with respect to the image acquisition unit 111 is parallel with the sea surface 125 where the feature point 211 exists. Thus, the calculation unit 115 expresses the position vector ^{HOR}P of the feature point 211 in the real space in the camera horizontal coordinate system Σ_{HOR} by the following formula (11).

$$[ Math . 11 ]$$

$${}^{HOR} P = \{ \begin{matrix}{P}_{x} \\ {P}_{y} \\ h\end{matrix} \} = \{ \begin{matrix}{P}_{x} \\ {P}_{y} \\ r \times {S}_{θ y}\end{matrix} \} \qquad ( 11 )$$

Here, Px and Py represent the x component and the y component of the position vector ^{HOR}P in the camera horizontal coordinate system Σ_{HOR}. Furthermore, h represents a height of the optical center of the image acquisition unit 111, which is the origin in the camera horizontal coordinate system Σ_{HOR}, from the sea surface 125. Additionally, θy represents an angle of the visual axis 120 with respect to the horizontal plane 122 corresponding to the xy plane of the camera horizontal coordinate system Σ_{HOR}, for example, an angle at which the visual axis 120 is rotated around the y-axis and moved until it matches with the horizontal plane 122. In FIG. 11, θy is a negative number.

Next, the calculation unit 115 solves equations for three variables b, Px, and Py using formulae (5), (10), and (11). For example, the calculation unit 115 carries out calculation as expressed in the following formula (12) from the formulae (5), (10), and (11).

$$\begin{matrix}[ Math . 12 ] & \\ b \times [ \begin{matrix}{c}_{θ y} & {s}_{θ y} {s}_{θ x} & {s}_{θ y} {c}_{θ x} \\ 0 & {c}_{θ x} & - {s}_{θ x} \\ - {s}_{θ y} & {c}_{θ y} {s}_{θ x} & {c}_{θ y} {c}_{θ x}\end{matrix} ] \times \{ \begin{matrix}f \\ {a}_{u} \times u \\ {a}_{v} \times v\end{matrix} \} = \{ \begin{matrix}{P}_{x} \\ {P}_{y} \\ r \times {s}_{θ y}\end{matrix} \} & ( 12 )\end{matrix}$$

$$b \times \{ \begin{matrix}{c}_{θ y} f + {s}_{θ y} {s}_{θ x} {a}_{u} \times u + {s}_{θ y} {c}_{θ x} {a}_{v} \times v \\ {c}_{θ x} {a}_{u} \times u - {s}_{θ x} {a}_{v} \times v \\ - {s}_{θ y} f + {c}_{θ y} {s}_{θ x} {a}_{u} \times u + {c}_{θ y} {c}_{θ x} {a}_{v} \times v\end{matrix} \} = \{ \begin{matrix}{P}_{x} \\ {P}_{y} \\ r \times {s}_{θ y}\end{matrix} \}$$

$$b \times \{ \begin{matrix}{c}_{θ y} f + {s}_{θ y} ( {s}_{θ x} {a}_{u} \times u + {c}_{θ x} {a}_{v} \times v ) \\ {c}_{θ x} {a}_{u} \times u - {s}_{θ x} {a}_{v} \times v \\ - {s}_{θ y} f + {c}_{θ y} ( {s}_{θ x} {a}_{u} \times u + {c}_{θ x} {a}_{v} \times v )\end{matrix} \} = \{ \begin{matrix}{P}_{x} \\ {P}_{y} \\ r \times {s}_{θ y}\end{matrix} \}$$

Then, the calculation unit 115 solves the formula (12) to obtain b as the following formula (13).

$$\begin{matrix}[ Math . 13 ] & \\ b = \frac{r \times {s}_{θ y}}{- {s}_{θ y} f + {c}_{θ y} ( {s}_{θ x} {a}_{u} \times u + {c}_{θ x} {a}_{v} \times v )} & ( 13 )\end{matrix}$$

Furthermore, the calculation unit 115 obtains Px as the following formula (14).

$$\begin{matrix}[ Math . 14 ] & \\ \begin{matrix}{P}_{x} = b \times \{ {c}_{θ y} f + {s}_{θ y} ( {s}_{θ x} {a}_{u} \times u + {c}_{θ x} {a}_{v} \times v ) \} \\ = \frac{r \times {s}_{θ y} \times \{ {c}_{θ y} f + {s}_{θ y} ( {s}_{θ x} {a}_{u} \times u + {c}_{θ x} {a}_{v} \times v \}}{- {s}_{θ y} f + {c}_{θ y} ( {s}_{θ x} {a}_{u} \times u + {c}_{θ x} {a}_{v} \times v )}\end{matrix} & ( 14 )\end{matrix}$$

Furthermore, the calculation unit 115 obtains Py as the following formula (15).

$$\begin{matrix}[ Math . 15 ] & \\ \begin{matrix}{P}_{y} = b \times \{ {c}_{θ x} {a}_{u} \times u + {s}_{θ x} {a}_{v} \times v ) \} \\ = \frac{r \times {s}_{θ y} \{ {c}_{θ x} {a}_{u} \times u - {s}_{θ x} {a}_{v} \times v \}}{- {s}_{θ y} f + {c}_{θ y} ( {s}_{θ x} {a}_{u} \times u + {c}_{θ x} {a}_{v} \times v )}\end{matrix} & ( 15 )\end{matrix}$$

Here, the calculation unit 115 may calculate u and v from the position of the feature point 211 in the screen obtained from the image recognition unit 114. Furthermore, the calculation unit 115 may set the distance obtained from the distance measurement unit 112 as r. Moreover, the calculation unit 115 may obtain Euler angles θx and θy representing the attitude of the camera coordinate system Σ_{CAM} with respect to the camera horizontal coordinate system Σ_{HDR} from the roll angle and pitch angle of the image acquisition unit 111 obtained from the inclination measurement unit 113.

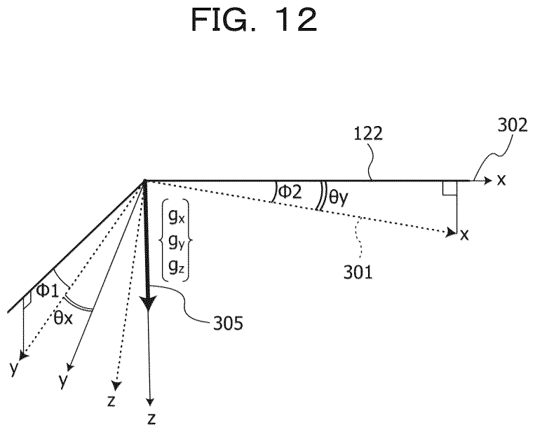

FIG. 12 is a diagram illustrating a relationship between an angle obtained from the inclination measurement unit and the Euler angle. FIG. 12 illustrates a relationship between the camera coordinate system Σ_{CAM} represented by the coordinate system 301, the camera horizontal coordinate system Σ_{HDR} represented by the coordinate system 302, and the horizontal plane 122. Furthermore, a vector 305 indicates a vertical direction toward the sea surface as viewed from the camera coordinate system Σ_{CAM}, and is represented by the matrix illustrated in FIG. 12.

The calculation unit 115 may calculate angles Φ1 and Φ2 in FIG. 12 from the roll angle and pitch angle of the image acquisition unit 111 obtained from the inclination measurement unit 113. For example, the calculation unit 115 calculates the Euler angles θx and θy as θy=Φ1 and Φx=arcsin(sin(θ)/cos(θy)).

Moreover, the calculation unit 115 may express the calculated Euler angles θx and θy as the following formulae (16) and (17) using the vector 305 corresponding to the vertical direction toward the sea surface as viewed from the camera coordinate system Σ_{CAM}.

$$\begin{matrix}[ Math . 16 ] & \\ θ x = arc sin ( - {\hat{g}}_{y} ) & ( 16 )\end{matrix}$$

$$\begin{matrix}[ Math . 17 ] & \\ θ y = arc tan ( \frac{{\hat{g}}_{x}}{{\hat{g}}_{z}} ) & ( 17 )\end{matrix}$$

As described above, the calculation unit 115 calculates Px and Py representing the position of the feature point 211 using the formulae (14) and (15). In this manner, the calculation unit 115 specifies ship information of a predetermined vessel based on the position, distance, and inclination angle of the feature point in the second coordinate system expressed by the formula (5).

Here, for example, in a case of u=0, Px and Py representing the position of the feature point 211 are expressed by the following formulae (18).

$$\begin{matrix}[ Math . 18 ] & \\ {P}_{x} = \frac{r \times {s}_{θ y} \times \{ {c}_{θ y} f + {s}_{θ y} {c}_{θ x} {a}_{v} \times v \}}{- {s}_{θ y} f + {c}_{θ y} {c}_{θ x} {a}_{v} \times v} & ( 18 )\end{matrix}$$

$${P}_{y} = \frac{- r \times {s}_{θ y} \times {s}_{θ x} {a}_{v} \times v}{- {s}_{θ y} f + {c}_{θ y} {c}_{θ x} {a}_{v} \times v}$$

Furthermore, for example, in a case of v=0, Px and Py representing the position of the feature point 211 are expressed by the following formulae (19).

$$\begin{matrix}[ Math . 19 ] & \\ {P}_{x} = \frac{r \times {s}_{θ y} \times \{ {c}_{θ y} f + {s}_{θ y} {s}_{θ x} {a}_{u} \times u \}}{- {s}_{θ y} f + {c}_{θ y} {s}_{θ x} {a}_{u} \times u} & ( 19 )\end{matrix}$$

$${P}_{y} = \frac{r \times {s}_{θ y} {c}_{θ x} {a}_{u} \times u}{- {s}_{θ y} f + {c}_{θ y} {s}_{θ x} {a}_{u} \times u}$$

Furthermore, for example, in a case of θx=0, Px and Py representing the position of the feature point 211 are expressed by the following formulae (20).

$$\begin{matrix}[ Math . 20 ] & \\ {P}_{x} = \frac{r \times {s}_{θ y} \times \{ {c}_{θ y} f + {s}_{θ y} {a}_{v} \times v \}}{- {s}_{θ y} f + {c}_{θ y} {a}_{v} \times v} & ( 20 )\end{matrix}$$

$${P}_{y} = \frac{r \times {s}_{θ y} {a}_{u} \times u}{- {s}_{θ y} f + {c}_{θ y} {a}_{v} \times v}$$

Furthermore, for example, in a case of θx=0 and u=0, Px and Py representing the position of the feature point 211 are expressed by the following formulae (21).

$$\begin{matrix}[ Math . 21 ] & \\ {P}_{x} = \frac{r \times {s}_{θ y} \times \{ {c}_{θ y} f + {s}_{θ y} {a}_{v} \times v \}}{- {s}_{θ y} f + {c}_{θ y} {a}_{v} \times v} & ( 21 )\end{matrix}$$

$${P}_{y} = 0$$

Furthermore, for example, in a case of θx=0 and v=0, Px and Py representing the position of the feature point 211 are expressed by the following formulae (22).

$$\begin{matrix}[ Math . 22 ] & \\ {P}_{x} = - r \times {c}_{θ y} & ( 22 )\end{matrix}$$

$${P}_{y} = - \frac{r \times {a}_{u} \times u}{f}$$

As described above, the calculation unit 115 calculates the position of the feature point 211 in the real space. For example, in a case of calculating a ship length, the calculation unit 115 calculates the position of the feature point 212 in the real space in a similar manner.

For example, when the coordinate value of the feature point 211 in the image coordinate system Σ_{IMG} is (u1, v1), the calculation unit 115 calculates (Pₓ₁, P_{y1}), which is a coordinate value representing the position of the feature point 211 in the real space, as the following formulae (23).

$$\begin{matrix}[ Math . 23 ] & \\ {P}_{x 1} = \frac{r \times {s}_{θ y} \times \{ {c}_{θ y} f + {s}_{θ y} ( {s}_{θ x} {a}_{u} \times u 1 + {c}_{θ x} {a}_{v} \times v 1 ) \}}{- {s}_{θ y} f + {c}_{θ y} ( {s}_{θ x} {a}_{u} \times u 1 + {c}_{θ x} {a}_{v} \times v 1 )} & ( 23 )\end{matrix}$$

$${P}_{y 1} = \frac{r \times {s}_{θ y} \{ {c}_{θ x} {a}_{u} \times u 1 - {s}_{θ x} {a}_{v} \times v 1 \}}{- {s}_{θ y} f + {c}_{θ y} ( {s}_{θ x} {a}_{u} \times u 1 + {c}_{θ x} {a}_{v} \times v 1 )}$$

Furthermore, when the coordinate value of the feature point 212 in the image coordinate system Σ_{IMG} is (u2, v2), the calculation unit 115 calculates (Pₓ₂, P_{y2}), which is a coordinate value representing the position of the feature point 212 in the real space, as the following formulae (24).

$$\begin{matrix}[ Math . 24 ] & \\ {P}_{x 2} = \frac{r \times {s}_{θ y} \times \{ {c}_{θ y} f + {s}_{θ y} ( {s}_{θ x} {a}_{u} \times u 2 + {c}_{θ x} {a}_{v} \times v 2 ) \}}{- {s}_{θ y} f + {c}_{θ y} ( {s}_{θ x} {a}_{u} \times u 2 + {c}_{θ x} {a}_{v} \times v 2 )} & ( 24 )\end{matrix}$$

$${P}_{y 2} = \frac{r \times {s}_{θ y} \{ {c}_{θ x} {a}_{u} \times u 2 - {s}_{θ x} {a}_{v} \times v 2 \}}{- {s}_{θ y} f + {c}_{θ y} ( {s}_{θ x} {a}_{u} \times u 2 + {c}_{θ x} {a}_{v} \times v 2 )}$$

Here, the parameters in the formulae (23) and (24) will be collectively described again. A distance along the visual axis 120 from the origin of the camera coordinate system Σ_{CAM} to the horizontal plane corresponding to the sea surface is represented by r. Furthermore, θx and θy represent Euler angles indicating the attitude of the camera coordinate system Σ_{CAM} with respect to the camera horizontal coordinate system Σ_{HDR}. Furthermore, f represents a focal length, which is a distance from the optical origin of the image acquisition unit 111 to the virtual projection plane 123. Furthermore, au and av represent conversion coefficients for converting the pixel position in the image coordinate system Σ_{IMG} into the screen coordinate system Σ_{SCR}.

Then, the calculation unit 115 may calculate a ship length L₁₋₂ by the following formula (25) using the positions of the feature points 211 and 212 in the real space.

$$\begin{matrix}[ Math . 25 ] & \\ {L}_{1 - 2} = \sqrt{{[ {Px}_{1} - {Px}_{2} ]}^{2} + {[ {Py}_{1} - {Py}_{2} ]}^{2}} & ( 25 )\end{matrix}$$

Furthermore, the calculation unit 115 may calculate the position of the vessel 21 by the following expression (26).

$$\begin{matrix}[ Math . 26 ] & \\ \frac{( {P}_{x 1} , {P}_{y 1} ) + ( {P}_{x 2} , {P}_{y 2} )}{2} & ( 26 )\end{matrix}$$

Furthermore, the calculation unit 115 may calculate the azimuth of the vessel 21 by the following expression (27).

$$\begin{matrix}[ Math . 27 ] & \\ a tan 2 ( \frac{( {P}_{x 2} - {P}_{x 1} )}{( {P}_{y 2} - {P}_{y 1} )} ) & ( 27 )\end{matrix}$$

The calculation unit 115 may calculate the ship width in a similar manner. Moreover, the calculation unit 115 obtains the position of the origin of the camera coordinate system Σ_{CAM} in the real space from a global positioning system (GPS) (not illustrated) installed in the ship information measurement device 100 or the unmanned aircraft 1. Then, the calculation unit 115 calculates the position and azimuth of the vessel 21 from the obtained feature points 211, 212, 221, and 222. Thereafter, the calculation unit 115 outputs, to the communication unit 116, information regarding the calculated position, dimension, and azimuth of the vessel 21.

Returning to FIG. 1, the description is continued. The communication unit 116 receives, from the calculation unit 115, an input of the information regarding the position, dimension, and azimuth of the vessel 21. Then, the communication unit 116 transmits, to a terminal device 3, the information regarding the position, dimension, and azimuth of the vessel 21 via an antenna (not illustrated) mounted on the unmanned aircraft 1.

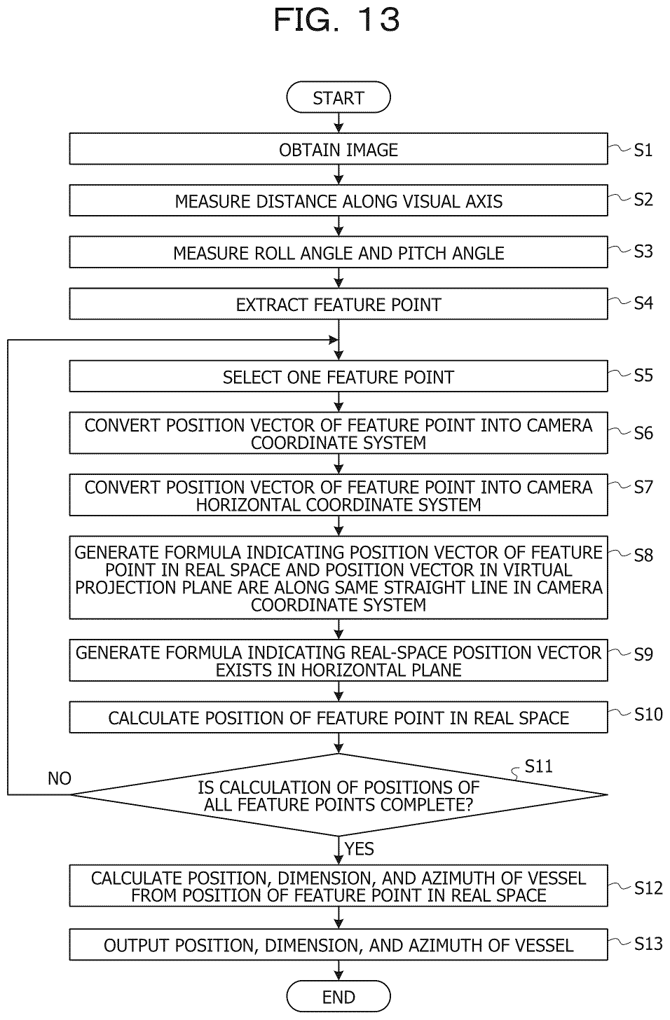

FIG. 13 is a flowchart of a process of measuring ship information performed by the ship information measurement device according to the embodiment. Next, the process of measuring the ship information performed by the ship information measurement device 100 according to the embodiment will be described with reference to FIG. 13.

The image acquisition unit 111 captures an image of the vessel 21 as an information measurement target to obtain the image of the vessel 21 (step S1).

The distance measurement unit 112 measures a distance along the visual axis 120 from the optical origin of the image acquisition unit 111 to the sea surface (step S2).

The inclination measurement unit 113 measures a roll angle and a pitch angle of the image recognition unit 114 (step S3).

The image recognition unit 114 inputs the image data of the vessel 21 obtained from the image acquisition unit 111 to the neural network 140 such as the HRNet, and obtains probability distribution of the positions of the feature points 211, 212, 221, and 222 as an output. Then, the image recognition unit 114 obtains the position of each point in the image, for example, the position vector of the image coordinate system θ_{IMG} using the obtained probability distribution, and extracts the feature points 211, 212, 221, and 222 (step S4).

The calculation unit 115 receives an input of the position vectors of the feature points 211, 212, 221, and 222 from the image recognition unit 114. Then, the calculation unit 115 selects one point from among the feature points 211, 212, 221, and 222 (step S5). Here, the selected point will be referred to as a “feature point 210” without distinguishing the feature points 211, 212, 221, and 222.

The calculation unit 115 converts the position vector of the feature point 210 in the image coordinate system Σ_{IMG} into a position vector in the camera coordinate system Σ_{CAM} using the formulae (1) and (4) (step S6).

Next, the calculation unit 115 converts the position vector of the feature point 210 in the camera coordinate system Σ_{CAM} into a position vector in the camera horizontal coordinate system Σ_{HDR} using the formula (5) (step S7).

Next, the calculation unit 115 generates the formula (10) indicating that the position vector ^{CAM}P of the feature point 210 in the real space and the position vector ^{CAM}p of the feature point 210 in the virtual projection plane 123 are along the same straight line in the camera coordinate system Σ_{CAM} (step S8).

Next, the calculation unit 115 generates the formula (11) indicating that the feature point 210 exists on a horizontal plane parallel to the horizontal plane 122 with respect to the image acquisition unit 111 (step S9).

Next, the calculation unit 115 calculates a position of the feature point 210 in the real space using the formulae (5), (10), and (11) (step S10).

Thereafter, the calculation unit 115 determines whether or not the calculation of the positions has been complete for all of the feature points 211, 212, 221, and 222 (step S11). If there remains a point where the calculation of the position is not complete among the feature points 211, 212, 221, and 222 (No in step S11), the calculation unit 115 returns to step S5.

On the other hand, if the calculation of the positions has been complete for all of the feature points 211, 212, 221, and 222 (Yes in step S11), the calculation unit 115 obtains the positional information of the origin of the camera coordinate system Σ_{CAM} from the GPS. Then, the calculation unit 115 calculates a position, dimension, and azimuth of the vessel from the positional information of the origin of the camera coordinate system Σ_{CAM} and the positional information of each of the feature points 211, 212, 221, and 222 (step S12).

The communication unit 116 outputs, to the terminal device 3, the information regarding the position, dimension, and azimuth of the vessel obtained from the calculation unit 115 (step S13).

As described above, the ship information measurement device 100 extracts feature points from the image data of the vessel 21, calculates positions of the extracted feature points, generates ship information including the position, dimension, and azimuth of the vessel 21 using the calculated positions, and makes notification. As a result, the ship information measurement device 100 is enabled to measure the ship information easily and accurately.

For example, the ship information measurement device 100 is enabled to accurately extract the feature points 211, 212, 221, and 222 associated with the position, dimension, and azimuth of the vessel 21 present in the screen by the image recognition unit 114 processing the vessel image obtained by the image acquisition unit 111. Then, the ship information measurement device 100 may automatically extract the feature points 211, 212, 221, and 222 without manual operation, which enables easy extraction of the feature points 211, 212, 221, and 222.

Furthermore, the ship information measurement device 100 uses, in addition to the measured distance and the roll angle and pitch angle of the image acquisition unit 111, the positional information of the feature point and the condition that the target vessel is on the horizontal plane to calculate the position, dimension, and azimuth of the vessel. As described above, the ship information measurement device 100 is enabled to carry out measurement with a simple configuration without separately measuring the measurement position of the laser and the position of the vessel 21, which enables easy acquisition of the ship information.

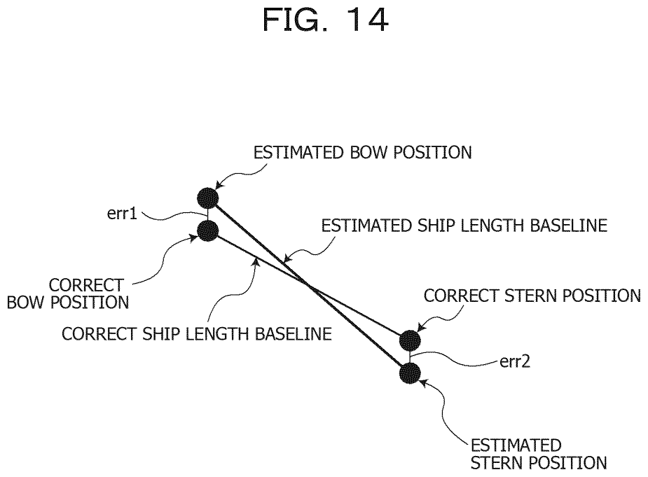

Moreover, an evaluation result of the image recognition process performed by the image recognition unit 114 of the ship information measurement device 100 will be described. FIG. 14 is a diagram for explaining calculation of a measurement error. Here, an evaluation was made based on the estimation accuracy of the ship length using estimation errors err1 and err2 illustrated in FIG. 14. The estimation error err1 is an error between the correct position of the bow and the estimated position of the bow. In addition, the estimation error err2 is an error between the correct position of the stern and the estimated position of the stern. Then, a sum of squares estimation error expressed as ((err1)²+(err2)²)^{1/2} was used.

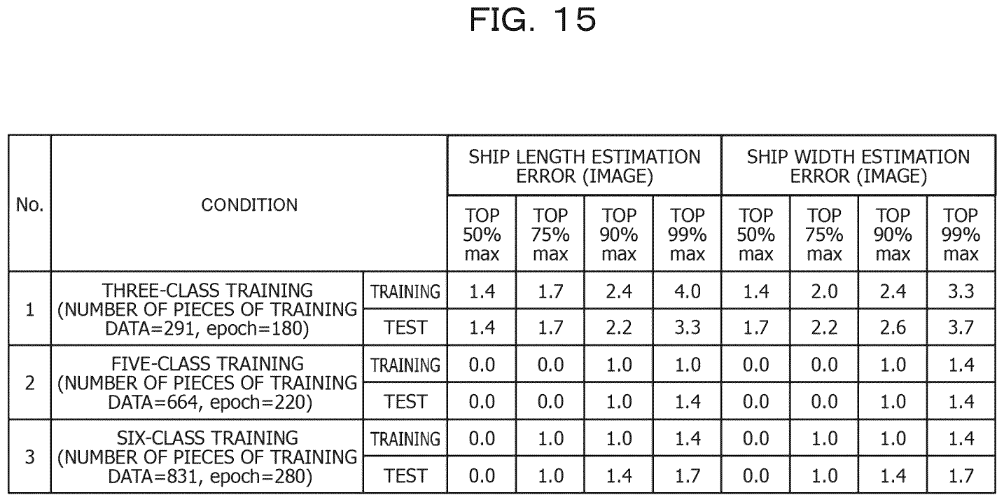

FIG. 15 is a diagram illustrating an accuracy measurement result. FIG. 15 illustrates a training result in each of the cases of classification into 3 classes, 5 classes, and 6 classes. As illustrated in FIG. 15, the ship length and the ship width may be measured with an error of approximately one to two pixels in the top 90% evaluation data when machine learning is carried out a sufficient number of times using a sufficient number of pieces of training data. Here, while the sufficient number of pieces of training data is 600 to 700 or more and the sufficient number of times of training is approximately 200 to 400 epochs in the present measurement result, the same degree of measurement accuracy may be expected under conditions similar to the present measurement result. The test data is preferably of the same type as the training data. Then, the estimation accuracy tends to improve as the number of pieces of training data increases.

For example, the position, dimension, and azimuth of the vessel 21 measured by the ship information measurement device 100 installed in the unmanned aircraft 1 may be used for coastal security, safety monitoring at a harbor, responding to a marine accident, and the like. For example, the information regarding the position, dimension, and azimuth of the vessel 21 obtained by the ship information measurement device 100 may be used for identification and behavior estimation of the vessel 21, and a shipping route of the vessel 21 may be predicted to enhance the safety monitoring at the harbor. Furthermore, a vessel is commonly equipped with an automatic identification system (AIS) to send a notice of the ship information of its own. Thus, the position, dimension, and azimuth of the vessel 21 measured by the ship information measurement device 100 normally coincide with the ship information from the AIS. On the other hand, it is conceivable that a suspicious vessel does not send a notice of the ship information from the AIS or outputs counterfeit information. In that case, information that does not coincide with the position, dimension, and azimuth of the vessel 21 measured by the ship information measurement device 100 is notified, whereby the suspicious vessel may be detected using the position, dimension, and azimuth of the vessel 21 measured by the ship information measurement device 100.

### (Hardware Configuration)

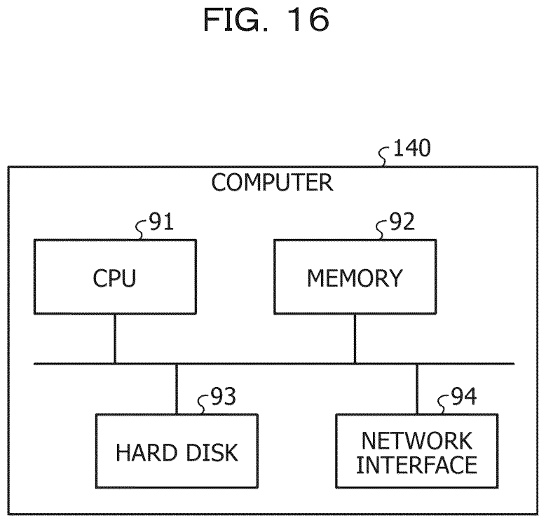

FIG. 16 is a hardware configuration diagram of a computer. Next, an exemplary hardware configuration for implementing each function of the computer 104 installed in the ship information measurement device 100 will be described with reference to FIG. 16.

As illustrated in FIG. 16, the computer 104 includes, for example, a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the computer 104 and an external device. The network interface 94 implements the function of the communication unit 116 exemplified in FIG. 5. For example, the network interface 94 relays communication between the terminal device 3 and the CPU 91 via the antenna mounted on the unmanned aircraft 1.

The hard disk 93 is an auxiliary storage device. The hard disk 93 stores various programs including programs for implementing the functions of the image recognition unit 114 and the calculation unit 115 exemplified in FIG. 5.

The memory 92 is a main storage device. For example, a dynamic random access memory (DRAM) may be used as the memory 92.

The CPU 91 reads various programs from the hard disk 93, and loads them into the memory 92 for execution. As a result, the CPU 91 implements the functions of the image recognition unit 114 and the calculation unit 115 exemplified in FIG. 5. Note that a graphics processing unit (GPU) and an embedded processor suitable for machine learning may be added to implement the functions of the image recognition unit 114 and the calculation unit 115 and to create a machine learning program to be used therefor.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process for measuring ship information, the process comprising:
imaging a predetermined vessel with an image acquisition device to obtain a captured image of the predetermined vessel;
extracting a feature point of the predetermined vessel in the captured image based on an output obtained by inputting the obtained captured image to a machine learning model that extracts a feature point of a vessel from an image;
obtaining a distance from the image acquisition device to a horizontal plane on which the predetermined vessel is positioned;
obtaining an inclination angle of the image acquisition device with respect to the horizontal plane; and
identifying the ship information of the predetermined vessel based on a position of the feature point in the captured image, the distance, and the inclination angle.

2. The non-transitory computer-readable recording medium according to claim 1, the medium storing the program for causing the computer to execute the process further comprising: causing the machine learning model to train to extract, as the feature point, a point according to a definition of a dimension of the vessel.

3. The non-transitory computer-readable recording medium according to claim 1, wherein
the extracting the feature point includes:
obtaining probability distribution of the feature point output from the machine learning model in the captured image; and
identifying the position of the feature point based on the probability distribution.

4. The non-transitory computer-readable recording medium according to claim 1, wherein
the identifying the ship information includes:
converting the position of the feature point in the captured image into a position in a first coordinate system with an imaging direction of the image acquisition device as a reference;
converting the position of the feature point in the first coordinate system into a position in a second coordinate system with a plane parallel to the horizontal plane as a reference; and
identifying the ship information of the predetermined vessel based on the position of the feature point, the distance, and the inclination angle in the second coordinate system.

5. A ship information measurement method for causing a computer to execute a process, the process comprising:
imaging a predetermined vessel with an image acquisition device to obtain a captured image of the predetermined vessel;
extracting a feature point of the predetermined vessel in the captured image based on an output obtained by inputting the obtained captured image to a machine learning model that extracts a feature point of a vessel from an image;
obtaining a distance from the image acquisition device to a horizontal plane on which the predetermined vessel is positioned;
obtaining an inclination angle of the image acquisition device with respect to the horizontal plane; and
identifying the ship information of the predetermined vessel based on a position of the feature point in the captured image, the distance, and the inclination angle.

6. A ship information measurement device comprising:
a memory; and
a processor coupled to the memory and configured to:
image a predetermined vessel with an image acquisition device to obtain a captured image of the predetermined vessel;
extract a feature point of the predetermined vessel in the captured image based on an output obtained by inputting the obtained captured image to a machine learning model that extracts a feature point of a vessel from an image;
obtain a distance from the image acquisition device to a horizontal plane on which the predetermined vessel is positioned;
obtain an inclination angle of the image acquisition device with respect to the horizontal plane; and
identify ship information of the predetermined vessel based on a position of the feature point in the captured image, the distance, and the inclination angle.
